(19) United States
(12) Patent Application Publication
(10) Pub. No.: US 2007/0158959 A1
(43) Pub. Date: Jul. 12, 2007

(54) Door handle structure requiring a smaller space for arranging a mechanism for releasing a door latch

(75) Inventor: Koichi Sakamoto, Sakura-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/641,572

(22) Filed: Dec. 19, 2006

(30) Foreign Application Priority Data
Dec. 27, 2005 (JP) 2005-374509

(51) Int. Cl. E05B 3/00

(52) U.S. Cl. 292/336.3

(57) ABSTRACT

A door handle for a vehicle includes: a main body held when the door is opened or closed; a lever member provided on an inner side of the main body in a freely rotatable manner; a handle case to which the main body and the lever member are attached; and a transmission device for transmitting rotation of the lever member to a latch mechanism of the door so as to release a latch state of the door. The transmission device has: a rotation member which is engaged with the lever member and rotates vertically in accordance with the rotation of the lever member; and a coupling member for coupling the rotation member and the latch mechanism with each other. A coupling part between the rotation member and the latch mechanism is positioned closer to a front surface of the door in comparison with a rotational center of the rotation member.

### BACKGROUND OF THE INVENTION

1. Field of the Invention

The present invention relates to a structure of a door handle provided on a surface of a door in a vehicle.

Priority is claimed on Japanese Patent Application No. 2005-374509, filed Dec. 27, 2005, the content of which is incorporated herein by reference.

2. Description of the Related Art

In a known example of a door handle structure, the latch state of the door is released by pulling a lever member which rotates inside a main body of the handle (see, for example, Japanese Unexamined Patent Application, First Publication No. 2001-193318).

In the above conventional structure, it is necessary to provide a mechanism for transmitting the rotation of the lever member to the latch mechanism inside the door; thus, a space for fitting the mechanism must be disposed inside the door, which may restrict flexibility in the parts layout.

### SUMMARY OF THE INVENTION

In light of the above circumstances, an object of the present invention is to provide a structure of a door handle which can save space, which is disposed on the inner side the handle main body, for arranging a mechanism for transmitting the rotation of the lever member, and can improve flexibility in the parts layout.

Therefore, the present invention provides a structure of a door handle (e.g., a door outer handle 7 in an embodiment explained later) provided on a surface of a door (e.g., a front door 2 in the embodiment) in a vehicle (e.g., a vehicle 1 in the embodiment), comprising:

a handle main body (e.g., a handle main body 51 in the embodiment) which is held when the door is opened or closed;

a lever member (e.g., a lever member 52 in the embodiment) provided on an inner side of the handle main body in a freely rotatable manner;

a handle case (e.g., a handle case 53 in the embodiment) to which the handle main body and the lever member are attached; and

a transmission device (e.g., a transmission mechanism 54 in the embodiment) for transmitting a rotating operation of the lever member to a latch mechanism (e.g., an electric lock unit 25 in the embodiment) of the door so as to release a latch state of the door, wherein:

the transmission device has:

a rotation member (e.g., a rotation plate 62 in the embodiment) which is engaged with the lever member and rotates vertically in accordance with the rotating operation of the lever member; and

a coupling member (e.g., a coupling rod 26 in the embodiment) for coupling the rotation member and the latch mechanism with each other; and

a coupling part (e.g., a coupling part C1 in the embodiment) between the rotation member and the latch mechanism is positioned closer to a front surface of the door in comparison with a rotational center (e.g., a rotational center C2 in the embodiment) of the rotation member.

In accordance with the above structure, the coupling part between the rotation member and the coupling member in the transmission device is positioned closer to the front surface of the door in comparison with the rotational center of the rotation member. Therefore, when the rotation member rotates, the coupling member and the coupling part cannot easily protrude toward the inside of the door. Therefore, even in the structure in which the lever member provided on the inner side of the handle main body is operated, the space necessary for arranging the transmission device on the inner side of the door can be reduced, thereby increasing flexibility in design of the parts layout.

In a typical example, the handle case has a shape protruding toward the inside of the door; and

the rotation member is arranged closer to the front surface of the door in comparison with a top part (e.g., a top part 57 in the embodiment) of the protruding shape of the handle case.

In this case, the rotation member can be arranged within a range necessary for arranging the handle case on the inner side of the door in the inner-to-outer direction of the door, thereby further providing space-saving.

In another typical example, the rotation member is arranged within a range defined by a vertical width of the handle case.

In this case, the rotation member can be arranged within the vertical range necessary for arranging the handle case on the inner side of the door, thereby further providing space-saving.

Preferably, the coupling part between the rotation member and the latch mechanism is positioned within a range defined by a front-to-back width of the handle case.

Also preferably, the rotation member is arranged substantially within a range defined by a front-to-back width of the handle case.

### BRIEF DESCRIPTION OF THE DRAWINGS

FIG. 1 is a side view showing a vehicle to which an embodiment of the present invention is applied.

FIG. 2 is a side view showing the front door on the right side of the vehicle, viewed from the inside of the vehicle.

FIG. 3 is a perspective view of the door outer handle of the front door on the right side of the vehicle, viewed obliquely from the back side.

FIG. 4 is a top view of the door outer handle in FIG. 3.

FIG. 5 is a back view of the door outer handle in FIG. 3.

### DETAILED DESCRIPTION OF THE INVENTION

Hereinafter, an embodiment in accordance with the present invention will be described with reference to the appended figures. In the following explanations, directions such as front, back, right, and left coincide with those of the vehicle if no specific explanation is provided. Additionally, in the figures, arrows indicated by reference symbols FR, LH and UP respectively designate the front side, the left side, and the upper side of the vehicle.

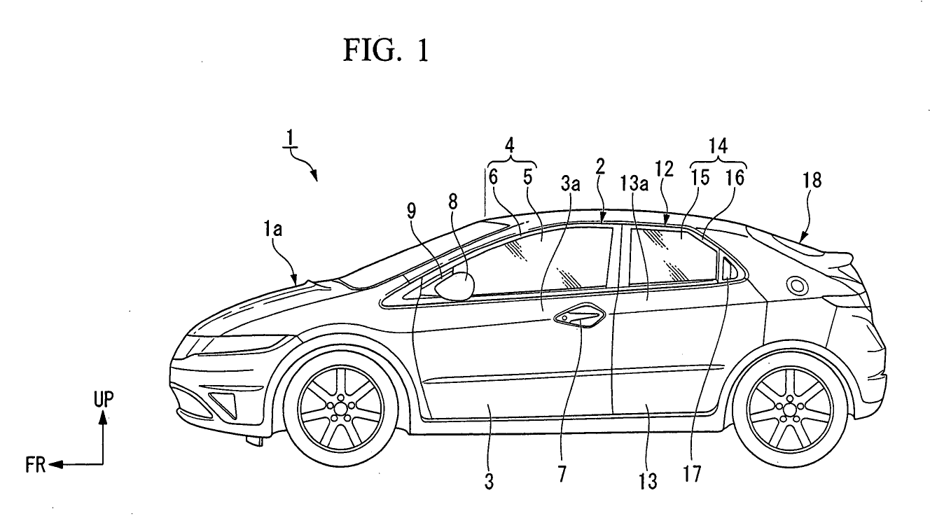

FIG. 1 is a side view showing a vehicle 1 in the embodiment. The vehicle 1 is a two-box type, and has a vehicle body 1a having a monocoque structure in which panel parts and vehicle-body frame parts are joined integrally to each other. Openings provided on each side of the vehicle are closed and opened using a front door 2 and a rear door 12. The front door 2 consists of a door main body 3 as a lower part of the door and a window part 4 as an upper part of the door, which are formed integrally, and the rear door 12 also consists of a door main body 13 and a window part 14, which are formed integrally. The window part 4 has main elements such as a door windowpane 5 and a sash 6, and similarly, the window part 14 has main elements such as a door windowpane 15 and a sash 16. The area surrounded by the sash 6 and a waist part 3a (which may be called a “door waist part” below), which is an upper end portion of the door main body 3, is closed and opened by raising and lowering the door windowpane 5. Similarly, the area surrounded by the sash 16 and a waist part 13a (which may also be called a “door waist part” below), which is an upper end portion of the door main body 13, is closed and opened by raising and lowering the door windowpane 15.

The front door 2 and the rear door 12 are each opened and closed around a hinge axis arranged at the front end (i.e., base end) of the door, along the substantially vertical direction.

A door outer handle 7 (i.e., a door handle) for opening and closing the front door 2 from the outside of the vehicle is provided at an upper-rear position in the door main body 3. A door outer handle 17 (i.e., a door handle) for opening and closing the rear door 12 from the outside of the vehicle is provided at a rear end position in the window part 14.

A mirror base plate 9 for supporting a door mirror 8 is attached to the front end of the window part 4 in the front door 2. In addition, reference numeral 18 indicates a tail gate for opening and closing an opening provided on the back side of the vehicle body.

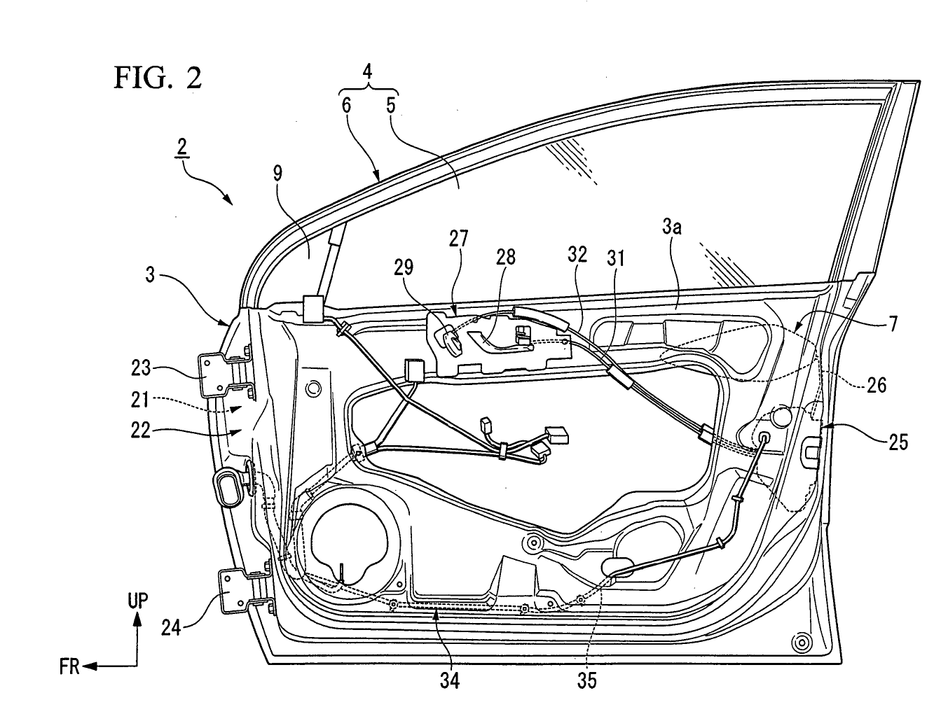

FIG. 2 is a side view showing the front door 2 on the right side of the vehicle, viewed from the inside of the vehicle. The door main body 3 of the front door 2 has a structure in which (i) a door skin 21 (i.e., an outer panel), made by press-forming a steel plate, for forming the outer side (i.e., toward the outside of the vehicle) of the main body 3 on the right side of the vehicle, and (ii) a door inner part 22 (i.e., an inner panel), also made by press-forming a steel plate, for forming the inner side (i.e., toward the interior of the vehicle) of the main body 3 on the right side of the vehicle, are combined integrally by hemming processing applied to the front, rear, and lower edges thereof. When considering the front door 2 on the left side of the vehicle, the above “right side” should be the “left side”. At the upper end portion (i.e., the waist part 3a) of the door main body 3, the door skin 21 and the door inner part 22 are separated from each other, so that the door windowpane 5 can enter and exit a space in the door main body 3 (i.e., a door inner-space) via the gap between the door skin 21 and the door inner part 22.

The sash 6 is made by subjecting a pipe member, having a specific non-uniform section, to bending processing or the like. The front and rear lower ends thereof are inserted into the front and rear ends of the waist part 3a in the door main body 3 from the upper side, and each inserted part and the part which receives it are combined integrally by welding or the like. The mirror base plate 9 is attached integrally between a front end portion of the sash 6 and a front end portion of the waist part 3a by welding or the like.

The front end (i.e., base end) of the door inner part 22 in the door main body 3 is supported at the front end of a side opening of the vehicle body in a freely rotatable manner via an upper hinge 23 and a lower hinge 24. On the other hand, on the inside of the rear end (i.e., free end) of the door main body 3, an electric lock unit 25 (i.e., a latch mechanism or an electric lock mechanism) is provided which is engageable with a rear portion of the side opening in the vehicle body, in a latch form. When this electric lock unit 25 is latch-engaged with the vehicle body 1a (i.e., the front door 2 is in a fully-closed state), the free end of the door main body 3 is supported at the rear end of the side opening in the vehicle body. Inside the door main body 3, a door beam (not shown) is arranged between the base end and the free end of the door main body 3.

On the surface (i.e., the door skin 21) of the door main body 3, the door outer handle 7 is provided. Inside the door main body 3, the electric lock unit 25 is provided below the door outer handle 7. To the electric lock unit 25, an end of a coupling rod 26 (i.e., a coupling member) is connected, which extends downward from the door outer handle 7. The electric lock unit 25 switches the locked state and the unlocked state thereof in accordance with an electrical signal supplied from a locking harness 35 which extends from a door harness 34. In the unlocked state of the electric lock unit 25, when the door opening operation using the door outer handle 7 is performed, this operation is transmitted via the coupling rod 26 to the electric lock unit 25, so that the (door) latch engagement between the vehicle body and the door is released.

Also to the electric lock unit 25, the heads of an inner handle cable 31 and a locking cable 32 are connected. These cables extend obliquely from an inner handle assembly 27 toward the lower-back side. The inner handle assembly 27 has a base plate to which an inner handle 28 and an inner lock lever 29 are attached in a rotatable manner, and it is fastened to the central part in an upper portion of the door inner part in the front-to-back direction. When the inner lock lever 29 is operated, this operation is transmitted via the locking cable 32 to the electric lock unit 25, and the electric lock unit 25 switches its state (i.e., between the locked state and the unlocked state). In the unlocked state of the electric lock unit 25, when the inner handle 28 is operated so as to open the door, this operation is transmitted via the inner handle cable 31 to the electric lock unit 25, so that the (door) latch engagement between the vehicle body and the door is released.

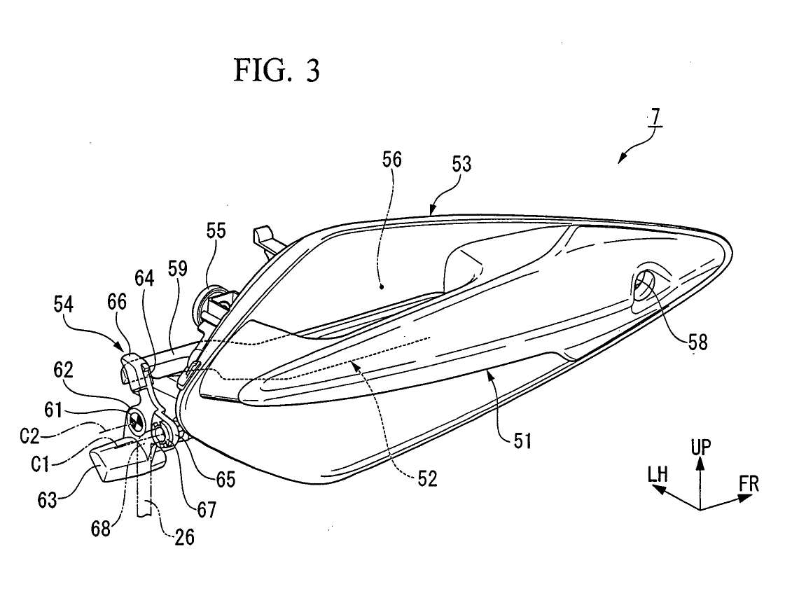

FIG. 3 is a perspective view of the door outer handle of the front door on the right side of the vehicle, viewed obliquely from the back side. As shown in FIG. 3, the door outer handle 7 has main structural parts such as: a handle main body 51 as a handle which is held when the front door 2 is opened or closed; a lever member 52 provided on the inner side of the handle main body 51 in a freely rotatable manner; a handle case 53 to which the handle main body 51 and the lever member 52 are attached; and a transmission mechanism 54 (i.e., a transmission device) for transmitting the rotation of the lever member 52 to the electric lock unit 25 so as to release the door latch.

In side view, the door outer handle 7 has a rhombic shape which is deformed in a manner such that the first half of the rhombus is longer than the latter half. Such a side-view shape is formed by the handle case 53.

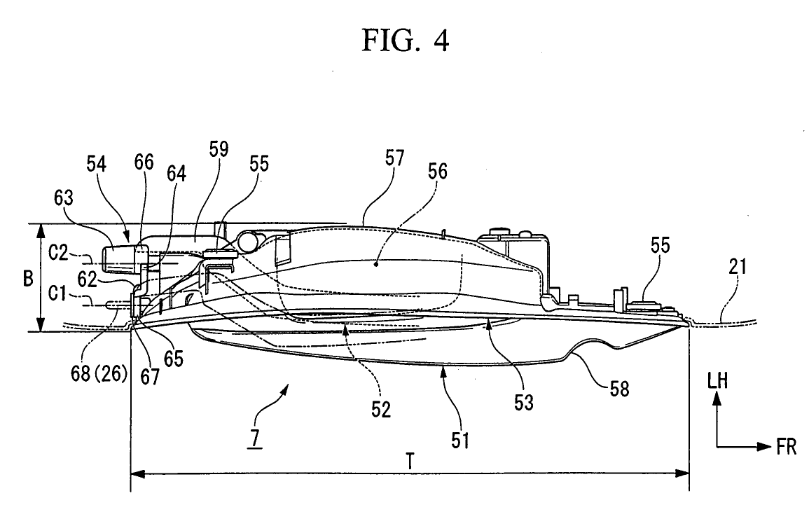

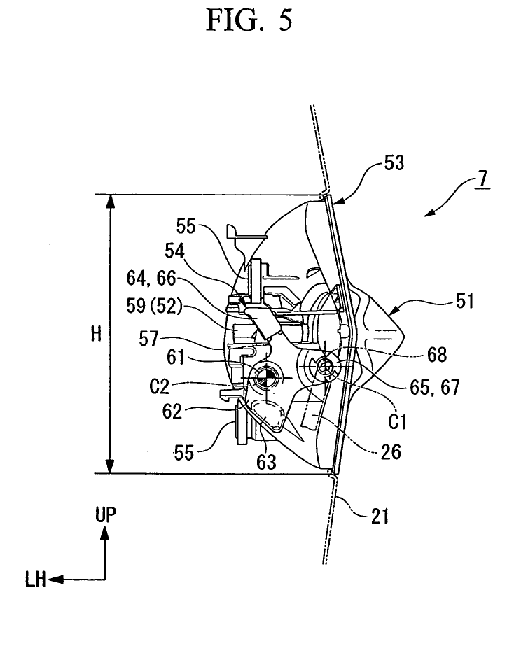

FIG. 4 is a top view of the door outer handle in FIG. 3, and FIG. 5 is a back view of this door outer handle.

Also with reference to FIGS. 4 and 5, the handle case 53 may be made of synthetic resin and has a cup shape having an arc-shaped section, which expands toward the interior of the vehicle (i.e., the inside of the door). The peripheral open edge of the handle case 53 toward the outside of the vehicle forms the above-described rhombic shape. On the inner side (toward the interior of the vehicle) of the handle case 53, fixed seatings 55, each having an inserted nut, are provided at three positions such as the front end, the upper side on the back, and the lower side of the center in the front-to back direction.

The door skin 21 has an opening which substantially conforms to the shape of the peripheral edge of the handle case 53. The door outer handle 7 is installed into this opening from the outside of the vehicle, and handle brackets (not shown) are attached to the handle case 53 from the interior of the vehicle. Specifically, the handle brackets are fastened to the corresponding fixed seatings using bolts, so that the peripheral edge of the handle case 53 and the handle brackets interpose the peripheral open edge of the door skin 21, thereby fastening the door outer handle 7 to the door skin 21.

The handle main body 51 may be made of synthetic resin, has a triangular section so as to protrude from the door skin 21 to the outside of the vehicle, and extends from the front side to the back side of the handle case 53. The handle main body 51 has a front part which conforms to the shape of the peripheral edge of the handle case 53, and the residual rear part of the handle main body 51 has a smaller vertical width (in comparison with the front part) which gradually decreases toward the back side. In the top view of the handle, this rear part is separated from the handle case 53 so that a holding space 56 is produced on the inner side (toward the interior of the vehicle) of the rear part, and thus the operator (for operating the door) can hold this rear part.

A top part 57 (i.e., closest to the interior of the vehicle) in the expanding form of the handle case 53 is positioned on the inner side of the rear part in the handle main body 51. In the front part of the handle main body 51, an attachment hole 58 for attaching a key cylinder (not shown) is provided, so as to switch the state of the electric lock unit 25 between the locked state and the unlocked state from the outside of the vehicle. Additionally, in order to secure a space for arranging the key cylinder, the handle case 53 has a front part which is generally flat without expanding toward the interior of the vehicle.

The lever member 52 provided on the inner side of the handle main body 51 may be made of synthetic resin, and protrudes toward the holding space 56 so as to secure a distance to the handle main body 51 (i.e., so that the lever member 52 can be pulled by a specific distance toward the outside of the vehicle). The lever member 52 extends along the handle main body 51 in the front-to-back direction, and the front end (i.e., base end) thereof is coupled to the handle main body 51 via a rotational shaft (not shown) which is arranged substantially vertically.

The lever member 52 is forced toward to a restriction position at which the rotation thereof toward the interior of the vehicle is restricted by a specific stopper. In such a state, the handle operator can insert fingers into the holding space 56, hold the lever member 52 by the fingers, and rotate (or move) it toward the outside of the vehicle against the force (toward the restriction position) applied to the lever member 52.

The lever member 52 has a rear end part which bends toward the interior of the vehicle and protrudes through the handle case 53 toward the interior of the vehicle. A fittable part 59 extends from the rear end part of the lever member 52 toward the back of the vehicle. The head of this fittable part 59 is engaged with the above-described transmission mechanism 54 for transmitting the rotating operation of the lever member 52 to the electric lock unit 25. That is, the latch engagement between the electric lock unit 25 and the vehicle body is released by transmitting the rotation of the lever member 52 via the transmission mechanism 54 to the electric lock unit 25.

The transmission mechanism 54 has main elements such as: a rotation plate 62 (i.e., rotation member) which has a bell-crank form and is supported by the handle case 53 in a freely rotatable manner via a rotating shaft 61 arranged substantially along the front-to-back direction; and the above-described coupling rod 26 arranged between the rotation plate 62 and the electric lock unit 25.

The rotation plate 62 may be a die casting of zinc, which has a plate form substantially perpendicular to the rotating shaft 61 and is formed integrally with the rotating shaft 61 and a counterweight 63 (explained later). The rotating shaft 61 is positioned below the fittable part 59. An input part 64 of the rotation plate 62 extends upward from the rotating shaft 61, and an output part 65 of the rotation plate 62 extends from the rotating shaft 61 toward the outside of the vehicle.

A resin cap 66 may be attached to the input part 64, and the fittable part 59 of the lever member 52 is engaged from the inside of the vehicle with the transmission mechanism 54 via the resin cap 66.

A resin holder 67 may be attached to the head of the output part 65, and a bent portion 68 formed at an end of the coupling rod 26 is engaged with the transmission mechanism 54 via the resin holder 67.

The coupling rod 26 is made by subjecting a steel material to a bending process or the like. The bent portion 68 is parallel to the rotating shaft 61, and the rotation plate 62 and the coupling rod 26 can relatively rotate with respect to each other around the bent portion 68 as the central axis. At least when the lever member 52 is not operated (i.e., not rotated), the axis C1 (see FIG. 4) of the bent portion 68 in the coupling rod 26 (i.e., the engaging or coupling part between the rotation plate 62 and the coupling rod 26, and simultaneously the center of the relative rotation) is positioned closer to the outside of the vehicle (i.e., the surface of the front door 2) in comparison with the axis C2 (i.e., the center of rotation) of the rotating shaft 61.

With respect to the above-described transmission mechanism 54, when the rotating operation of the lever member 52 (i.e., pulling operation toward the outside of the vehicle) is performed, the fittable part 59 rotates the rotation plate 62 in the vertical direction (i.e., in the upper-to-lower direction around the rotating shaft 61) so as to move the input part 64 of the rotation plate 62 toward the outside of the vehicle, and such rotation of the rotation plate 62 moves the head part of the output part 65 in the rotation plate 62 downward. Accordingly, the coupling rod 26 is pushed downward and operates the electric lock unit 25 so as to release the latch engagement between the electric lock unit 25 and the vehicle body. The rotation plate 62 is forced in the reverse direction with respect to the rotation of the lever member 52. Additionally, in the rotation plate 62, the above-described counterweight 63 is positioned below the rotating shaft 61 in consideration of a side impact.

In the top view of the handle, the rotation plate 62 and the fittable part 59 are arranged adjacent to the inclined part formed on the rear side of the handle case 53, which has the expanded form. Accordingly, they are positioned closer to the outside of the vehicle (i.e., the door skin 21) in comparison with the top part 57 (toward the interior of the vehicle) of the expanded form, and thus do not protrude from the position of the top part 57 toward the interior of the vehicle. That is, the rotation plate 62 and the fittable part 59 are arranged within the range defined by the width B (see FIG. 4) of the handle case 53 in the inside-to-outside direction, and thus do not increase the width of the door outer handle 7 in the inside-to-outside direction.

In addition, the rotation plate 62 and the fittable part 59 are arranged closer to the front of the vehicle in comparison with the rear end of the handle case 53 except for the counterweight 63; thus, a smaller length protrudes backward from the front-to-rear width T (see FIG. 4) of the handle case 53, thereby resulting in a minimum increase in the front-to-rear width of the door outer handle 7.

Furthermore, the rotation plate 62 and the fittable part 59 are arranged within the range defined by the vertical width H of the handle case 53, and thus they do not increase the vertical width of the handle case 53.

Additionally, in the back view of the handle, the rotation plate 62 and the fittable part 59 are arranged closer to the outside of the vehicle in comparison with the expanded form (or line) of the handle case 53. Therefore, they do not protrude from the handle case 53 toward the interior of the vehicle. In particular, also in the back view of the handle, the counterweight 63 has an inclined form in conformity with the expanded form of the handle case 53.

As described above, the door handle structure of the above embodiment is applied to the door outer handle 7 provided on the surface of the front door 2 in the vehicle 1, and has: the handle main body 51 held by the operator when the front door 2 is opened or closed; the lever member 52 provided on the inner side of the handle main body 51 in a freely rotatable manner; the handle case 53 to which the handle main body 51 and the lever member 52 are attached; and the transmission mechanism 54 for transmitting the rotation of the lever member 52 to the electric lock unit 25 of the front door 2 so as to release the door latch state. The transmission mechanism 54 has: the rotation plate 62 which is engaged with the lever member 52 and rotates vertically in accordance with the rotation of the lever member 52; and the coupling rod 26 for coupling the rotation plate 62 and the electric lock unit 25 with each other. The coupling part C1 between the rotation plate 62 and the coupling rod 26 is positioned closer to the front surface of the front door 2 in comparison with the rotational center C2 of the rotation plate 62.

In accordance with the above structure, the coupling or engagement part C1 between the rotation plate 62 and the coupling rod 26 in the transmission mechanism 54 is positioned closer to the front surface of the front door 2 in comparison with the rotational center C2 of the rotation plate 62. Therefore, when the rotation plate 62 rotates, the coupling rod 26 and the coupling part C1 cannot easily protrude toward the inside of the front door 2. Therefore, even in the structure in which the lever member 52 provided on the inner side of the handle main body 51 is operated, the space necessary for arranging the transmission mechanism 54 on the inner side of the front door 2 can be reduced, thereby increasing flexibility in design of the parts layout.

Also in the above door handle structure, the handle case 53 has a protruding shape which protrudes toward the inner side of the front door 2, and the rotation plate 62 is arranged closer to the front surface of the front door 2 in comparison with the top part 57 of the protruding shape of the handle case 53. Therefore, the rotation plate 62 can be arranged within a range necessary for arranging the handle case 53 on the inner side of the front door 2 in the inner-to-outer direction of the door (i.e., within the width B of the handle case 53 in the inner-to-outer direction), thereby further providing space-saving.

Also in the above door handle structure, the rotation plate 62 is arranged within the vertical width H of the handle case 53; thus, the rotation plate 62 can be arranged within the vertical range necessary for arranging the handle case 53 on the inner side of the front door 2, thereby further providing space-saving.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the of the appended claims.

For example, in the door outer handle 7, a cable may be used instead of the coupling rod 26, or a rotating shaft may be provided at a rear end of the lever member 52. In addition, the present invention can be applied not only to the front door 2, but also to the rear door 21, or the tail gate 18.

In addition, the material, form, or the like of the door outer handle 7 can be freely modified without departing from the scope of the present invention.

What is claimed is:

1. A structure of a door handle provided on a surface of a door in a vehicle, comprising:
a handle main body which is held when the door is opened or closed;
a lever member provided on an inner side of the handle main body in a freely rotatable manner;
a handle case to which the handle main body and the lever member are attached; and
a transmission device for transmitting a rotating operation of the lever member to a latch mechanism of the door so as to release a latch state of the door, wherein:
the transmission device has:
a rotation member which is engaged with the lever member and rotates vertically in accordance with the rotating operation of the lever member; and
a coupling member for coupling the rotation member and the latch mechanism with each other; and
a coupling part between the rotation member and the latch mechanism is positioned closer to a front surface of the door in comparison with a rotational center of the rotation member.

2. The structure in accordance with claim 1, wherein:
the handle case has a shape protruding toward the inside of the door; and
the rotation member is arranged closer to the front surface of the door in comparison with a top part of the protruding shape of the handle case.

3. The structure in accordance with claim 1, wherein the rotation member is arranged within a range defined by a vertical width of the handle case.

4. The structure in accordance with claim 1, wherein the coupling part between the rotation member and the latch mechanism is positioned within a range defined by a front-to-back width of the handle case.

5. The structure in accordance with claim 1, wherein the rotation member is arranged substantially within a range defined by a front-to-back width of the handle case.
